(19) United States
(12) Patent Application Publication
(10) Pub. No.: US 2014/0143008 A1
(43) Pub. Date: May 22, 2014

(54) PROCESS REVIEW SYSTEM FOR BECOMING GLOBALLY COMPETITIVE

(71) Applicants: J. Nirdosh Reddy, Bloomfield Hills, MI (US); Arvind J. Reddy, Royal Oak, MI (US)

(72) Inventors: J. Nirdosh Reddy, Bloomfield Hills, MI (US); Arvind J. Reddy, Royal Oak, MI (US)

(21) Appl. No.: 13/683,805

(22) Filed: Nov. 21, 2012

(51) Int. Cl. G06Q 10/06

(52) U.S. Cl. CPC G06Q 10/0633
USPC 705/7.27

(57) ABSTRACT

A computer system that manages the processes of an organization. The system defines a global process flowchart, which has a set of processes, where at least one of the processes has a macro flowchart that has a sub-process with a micro flowchart. The set of processes includes a set of primary processes and at least one enabling process. The primary processes process orders and the enabling processes help the primary processes. The computer system associates individual process summaries to processes from the global process flowchart. Each process summary has related processes like a customer process, supplier process or interfacing process. The computer system associates the related process to parameters that measures an aspect of the process. The computer system receives actual measurement data for the parameters. The computer system generates reports about the parameters missing data and data that fails to meet expectations and improvement plans that are behind schedule.

### BACKGROUND OF THE INVENTION

1. Field of the Invention

This invention relates generally to a system for tracking and managing business processes as related to the strategic goals of an organization, and, more particularly, to a system for determining expectations for the inputs and outputs to processes and gathering data against those expectations and from that information developing process-improvement projects and tracking their implementation.

2. Discussion of the Related Art

In the increasingly competitive environment that exists today, it has become evident that while technological breakthroughs are necessary, they are no longer sufficient to provide organizations with a lasting advantage. In order to obtain a sustainable competitive edge, companies must increase quality and productivity by utilizing more of their employees' abilities, in addition to striving for technological breakthroughs.

High performance companies often rely on process-oriented thinking, teamwork, and employee involvement, making these principles cornerstones of their organization. However, it is often a challenge to establish these principles and an even bigger challenge to have these principles continue to grow and thrive. For an organization to improve, it must establish, monitor and reinforce these principles as attributes of their business.

To enable an organization to adopt and thrive with these attributes as guiding principles of the emerging philosophy, a fundamental shift in management style is sometimes required to move from only managing people to managing processes and people. At an organization, all work is done as part of some process. Since results come from processes (systems), everyone's job is to control and improve the processes assigned to them. Accordingly, a fundamental shift in management style is required to move from managing people to leading people and managing processes.

What is needed is a system that helps an organization transform to this new and better management culture.

### SUMMARY OF THE INVENTION

In accordance with the teachings of the present invention, a computer system for managing processes in an organization is disclosed. The computer system executes programming instructions that determine a process flow for an organization with a global process flowchart. The global process flowchart has a set of processes, where at least one of the processes has a macro flowchart that has a sub-process, and the sub-process has a micro flowchart. The set of processes includes a set of primary processes and at least one enabling process, where the set of primary processes process orders, and where the enabling process enables the primary processes to perform their functions. The set of processes includes a second process that is associated with a process leader who is responsible for the second process. The computer system associates individual process summaries to processes from the set of processes. Each process summary has at least one related process like a customer process, supplier process or interfacing process. The computer system associates a parameter to measure, where the parameter measures an aspect of the process and is related to the related process, with expectations for the measured values. The computer system receives actual measurements of the parameter from the process. The computer system associates organizational goals to the process. The computer system generates a report about those measurement expectations that are missing actual data and those with actual data which fail to meet the measurement expectations. The computer system reports about the status of improvement projects necessary to achieve the organization's strategic goals.

Additional features of the present invention will become apparent from the following description and appended claims, taken in conjunction with the accompanying drawings.

### BRIEF DESCRIPTION OF THE DRAWINGS

FIG. 1 is a block diagram of a networked computer system for ongoing review and improvement of organizational processes;

FIG. 2 is an exemplary flowchart of the system for ongoing review and improvement of organizational processes;

FIG. 3 is a screenshot of an embodiment of the system showing a global process flowchart;

FIG. 4 is a screen shot of an embodiment of the system showing a process summary input screen;

FIG. 5 is a screen shot of an embodiment of the system showing a macro flowchart;

FIG. 6 is a screen shot of an embodiment of the system showing a micro flowchart;

FIG. 7 is a screen shot of an embodiment of the system showing a summary of the macro and micro flowcharts;

FIG. 8 is a screen shot of an embodiment of the system showing alerts and notifications;

FIG. 9 is a screen shot of an embodiment of the system showing expectation parameters being specified;

FIG. 10 is a screen shot of an embodiment of the system showing a data analysis screen;

FIG. 11 is a screen shot of an embodiment of the system showing an exception report;

FIG. 12 is an example of a process improvement document; and

FIG. 13 is a screen shot of an embodiment of the system showing a summary of process improvement plans; and

FIG. 14 is an example of a Goals—Subapproaches Matrix (GSM) Sheet.

### DETAILED DESCRIPTION OF THE EMBODIMENTS

The following discussion of the embodiments of the invention directed to an electronic system for documenting an organization's processes, and tracking and improving the processes is merely exemplary in nature, and is in no way intended to limit the invention or its applications or uses.

This system is an integrated tool and method that provides the ability to define and manage an organization's systems and processes and continually focus on communicating to the members of the organization the need to improve the effectiveness and efficiency of the organization's systems and processes. This system enables the capture and display of the work of an entire organization as a network of processes. The system enables users to describe an organization's processes and creates an infrastructure to promote and capture organizational learning and facilitate ‘knowledge management’. The system helps to systematically integrate all relevant information needed to improve internal and external customer satisfaction.

The purpose of the system is to clarify to everyone in the organization, not merely what he or she is supposed to do, but also to show how the processes actually get the work done. The system provides insight into who receives the output, what they are receiving, and what needs to be improved. The system helps get everyone to focus on satisfying his or her customers, both internal and external. The system brings a sense of ownership of processes, not only to the managers (process leader) but also to the individual workers (process owners). The system facilitates making continuous improvement as a way of life.

For purposes of this application, the word ‘organization’ can be an entire company or a business unit of a large company, in either case it is an enterprise focused on a business segment.

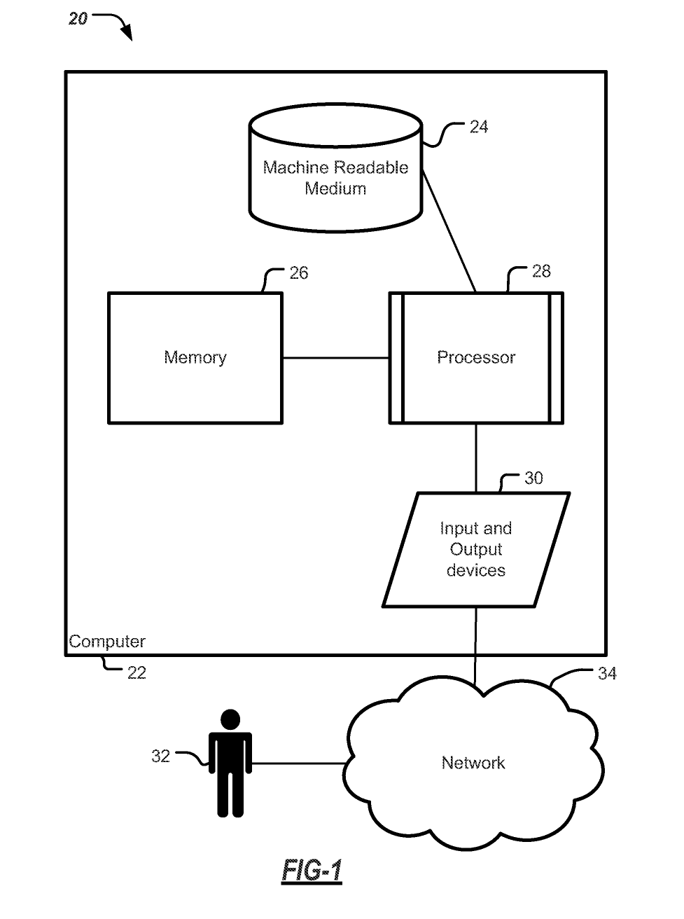

FIG. 1 illustrates a networked computer system 20 that can be configured into a special purpose computer that implements the system described in this specification. A computer 22 includes a machine readable medium 24, a memory 26, a processor 28, and an input and output devices 30. The machine readable medium 24 could be a disk drive, thumb drive, CD, DVD or other device capable of being read by the processor 28. The machine readable medium 44 contains program instructions and data where the program instructions and data can be run on the processor 28 with the memory 26 to create the functionality described in this application. The computer 22, using the input and output devices 30, can communicate on the network 34 to a user 32.

With a computer, like the computer 22, programmed to accomplish the functionality described in this specification the computer creates what is referred to throughout this specification as “the system.”

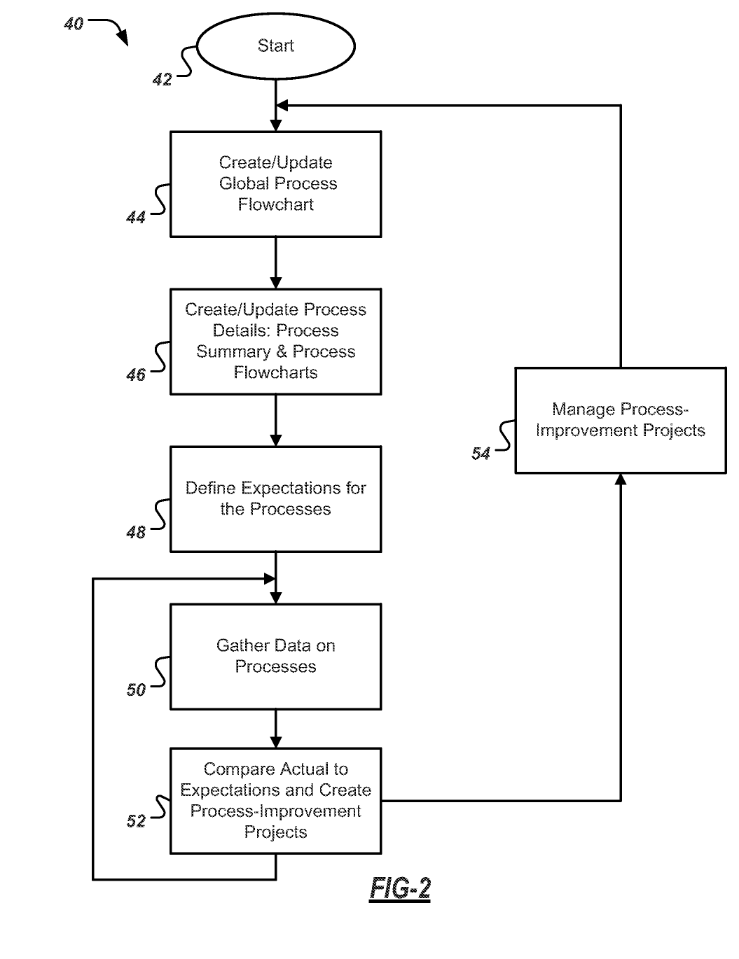

FIG. 2 is an exemplary flow chart 40 for the system running on the computer 22. The system starts at oval 42 at the initiation of a process review system for becoming globally competitive. The first step is at box 44 where the system has a user specify a global process flowchart for the organization that includes high-level process-boxes for all major processes in the organization. This establishes a bird's eye view of the entire organization. Next, at box 46, for each process-box on the global process flowchart, the system has the users create process summaries and process flowcharts. As part of the process summary, the system identifies downstream customers, upstream suppliers and other interfacing processes. Next, at box 48, the system has the user define the expectations of customer processes, supplier processes and interfacing processes. Customers and suppliers can be internal to the organization or external to the organization. One customer that always exists is the organization's management. Next, at box 50, the system collects actual data on the process's performance relative to the expectations. At box 52, the system looks for process-improvement opportunities where the actual data does not match expectations. The process continues by returning to the box 50 to collect more data. If the process-improvement opportunity becomes a process-improvement project, then the system tracks the process-improvement project, at box 54, and the improvements from the project are documented in the system starting again at the boxes 44 and 46 with updates to the flowcharts.

Information corresponding to the organizational processes is stored in the system and updated over time. When the system receives an updated (revised) process flowchart, the system assigns a version number, the updated flowchart and records a revision date, who prepared the revision and who approved the revision. The system provides a single location to hold process information for an organization. The system could also be capable of rolling back to an earlier version of the process, which may be appropriate if implementing the new version did not improve the process as anticipated.

The system makes readily available the latest performance data for each area of the business. The system provides an up-to-date exception report highlighting areas that are not meeting expectations. The system helps in a crisis to find the underlying cause of problems and to focus on areas that require improvement. The system can record the status of all process-improvement project documents.

There are four user roles defined in the system including administrator (coordinator), sponsor (senior manager), process leader (middle manager) and process owner (workers). The administrator is the coordinator, i.e., the person assigned the responsibility to set up and maintain the system, and is typically from middle management ranks and takes direction from the CEO. Sponsors are typically members of the top management group of the organization. Usually, the sponsor has several processes under his/her guidance. The process leaders are middle managers responsible for a process, which is usually only one process, but on occasion can be more than one process. The process owners are workers who are involved in carrying out the conduct of a process. All employees are owners of at least one process.

The administrator has the responsibility to ensure the global process flowchart is approved. This embodiment describes the administrator in the singular, but another embodiment of the system could have more than one person fulfilling the administrator roll. The administrator works with the CEO to create and update to the global process flowchart of the organization. The CEO is the person who heads the organization, and may have other titles such as president, business head, unit head, General Manager, etc. The administrator would typically get direction from the CEO. For each process, the administrator assigns a sponsor and with the sponsor's participation assigns the process leaders. The administrator works with the process leaders to assign and approve process owners. The administrator creates and updates a user access list with appropriate privileges in the system.

The sponsors are responsible for approving changes to their processes' macro flowcharts and expectations. The sponsors should remember that people do what is inspected not what is expected. What gets reviewed gets done. Because “Results come from processes (systems),” that means one needs to focus on improving processes in order to get better results. Managing with facts requires relentless pursuit of facts, keeping in mind that when things go wrong, one needs to ask first what in the process broke down, not who did it. The sponsors are senior management and the system helps them stay on top of the performance of the processes, focus on the areas that require improvement, stay up-to-date on the status of improvement projects and capture data on interfacing processes.

The process leader's responsibilities are to use the system to create and make improvements to the macro flowcharts for their processes, approve changes to micro flowcharts of their processes, keep data updated and keep improvement plans updated. When a process-improvement project is initiated, the process leader should hold regular meetings to ensure the process improvement teams systematically follow the steps of the process-improvement process. The system helps the process leader document the real processes. Having the real processes documented helps simplify training people that are new to the process, minimize repetitive inquiries from others, make it easier to maintain data relative to internal and external customers' expectations, make it easier to capture and integrate the knowledge gained from improvements in day-to-day activities, facilitates dialogue with internal suppliers and interfacing processes, and helps in other ways.

The process owner's responsibilities are to use the system to define and make improvements to their processes to their micro flowcharts and collect data on customer expectations. The system helps the process owner (actual doer—either planning or implementation) by providing clear instructions on how to perform work functions, facilitating employees becoming multi-skilled, capturing accurate data, providing data needed to make decisions based on facts rather than opinions, and showcasing improvements being made.

This specification describes specific roles and their responsibilities of one possible embodiment. However, in any particular embodiment the actual roles and responsibilities could be adjusted and could be different from the roles and responsibilities discussed here.

### Global Process Flowchart

Ask a CEO how their organization is organized and what they are likely to show is an organization chart with groups of people and who reports to whom. However, this focus on people can be misguided. A guiding principle is “Results come from processes (systems)”. Whatever an organization is achieving today—good or not so good—comes from the way things are done in the organization.

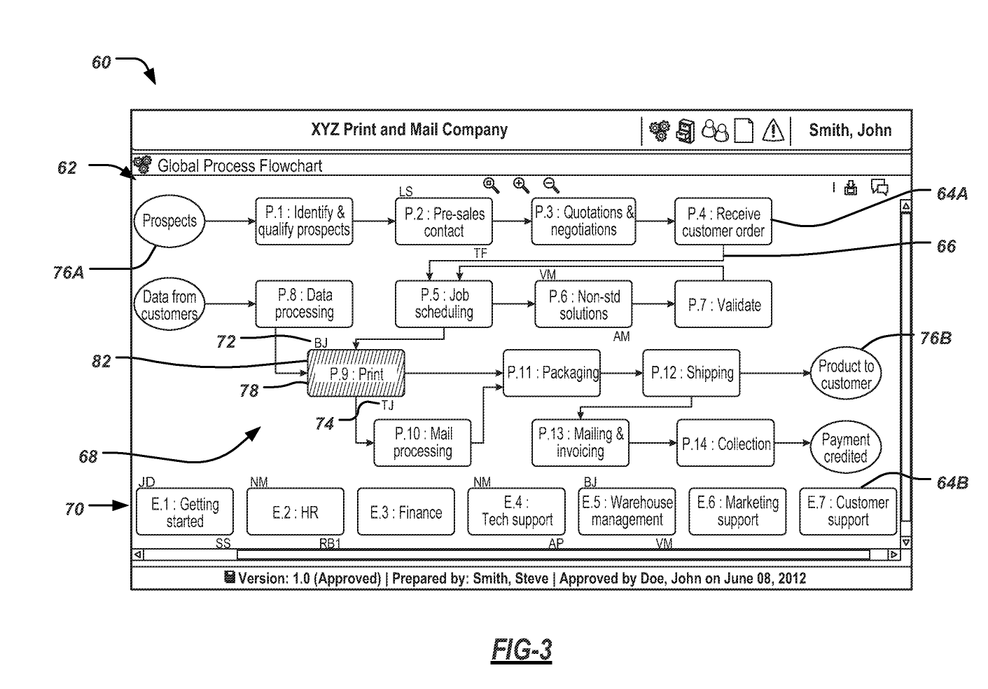

The competitive edge for every organization lies in the quality of products and services it delivers, the speed of delivery of its products and services and the cost-of-ownership for the products and services. Therefore, the objective of every organization is to process customer orders with the highest quality, as fast as possible and with the lowest possible cost. To help achieve a competitive edge, the organization needs to know who is responsible for each process in the chain of actions starting from the initial interactions with a potential customer and ending with collecting payments after delivery of the product or service. The system enables the organization to describe itself as a collection of processes. The highest-level process flowchart is called the global process flowchart. FIG. 3 shows a screenshot 60 from an embodiment of the system that includes a global process flowchart 62 for an organization that does printing and mailing. The system shows the processes represented as boxes (process-boxes 64) and shows interconnections between processes with lines 66 having arrows on the end indicating process flow.

This specification uses the following definitions related to the global process flowchart.

Global process flowchart—a flowchart that depicts the processes for an entire organization from the beginning sales activities until the delivery of the products or services to the customer. It contains both primary processes and enabling processes. In the embodiment shown in FIG. 3, the primary processes are shown as a set of interconnecting process-boxes 68. Enabling processes are shown as separate process-boxes 70 at the bottom of the global process flowchart 62.

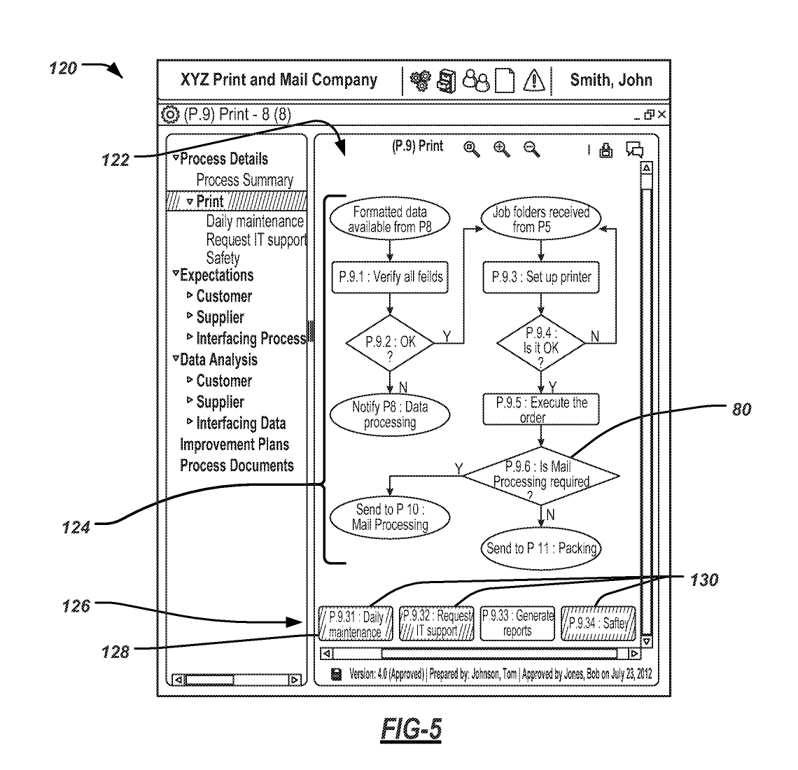

Process—a sequence of steps that consist of activities and decisions. A flowchart is a tool used to describe a process. A flowchart has activities depicted with rectangles, beginning and ending of processes depicted with ovals and decisions depicted with diamonds. A flowchart shape with more detail available can be indicated on the flowchart, for example, with shading or with a “+” symbol. FIG. 3 shows a flowchart with activity rectangles 64A 64B, a beginning oval 76A and an ending oval 76B. Shapes with more detail are shaded 78. FIG. 5 shows a flowchart with a decision diamond 80.

Primary processes—processes in the sequence starting from order generation and ending with dispatch and invoicing. The primary processes are shown with primary process-boxes that have lines entering and exiting them to show the path customer orders take within the organization. The primary processes are not departments. A department may have more than one process with some in the primary flow and some in the enabling category.

Enabling processes—processes that enable the primary processes to perform their functions. Without the help and support from these enabling processes, the primary processes will not be able to accomplish their mission. Enabling processes are inherently cross-functional in nature.

Sponsor—a member of the top management of the organization who typically oversees more than one process-box on the global process flowchart. The system can show the sponsor name or sponsor initials at the top of the process-box. FIG. 3 shows sponsor initials 72 at the top of a process-box 82.

Process leader—a person designated to look after a process, where there is typically one process leader for one process-box on the global process flowchart. In a multi-shift operation, it is possible to have more than one person responsible, since different people would be responsible for the same process in different shifts. The system can show an indication of the process leader by the process-box, for example, the process leaders name or initials can be shown at the bottom of the process-box. FIG. 3 shows process leader initials 74 at the bottom of a process-box 82.

Process owner—a person involved in performing the steps of a process. The actual doer is the owner of those activities, be it planning or execution.

The system can ask the user to enter a description of the organization's line-of-business. The system can ask the user to state in two or three sentences the products and services that the organization provides the market segment that their organization operates in and the geographic area that their organization serves.

The entire organization should be described using about fifteen to twenty-five primary processes and fifteen to twenty-five enabling processes. It is important to identify all processes of the organization, with both primary processes and enabling processes being important.

The system creates labels for the process-boxes. The primary processes can have labels that begin with P followed by a sequential number, for example, P.1, P.2, P.3, etc. The enabling processes can have labels that begin with E followed by a sequential number, for example, E.1, E.2, E.3, etc. The system records the sponsor and process leader for each process on the global process flowchart.

The system can capture the expectations of subsequent processes. The system helps the organization focus on the fact that—in order to satisfy external customers—first internal customers have to be satisfied. The system helps ensure that management's expectations reinforce the expectations of internal customers. There needs to be alignment of the external and internal customer expectations for the ultimate customers to get what they expect. If there is a conflict between internal and external expectations, then the ultimate customer is unlikely to get what they expect.

### Process Summary & Process Flowcharts

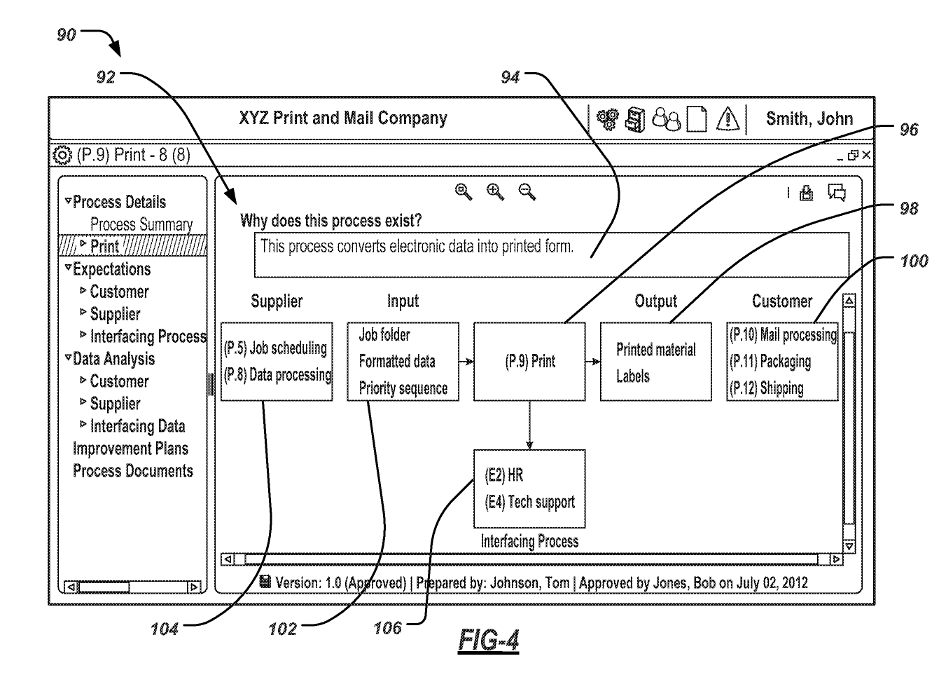

The system has the process leaders describe the actual processes followed in their area in process summaries (see FIG. 4) and process flowcharts (see FIG. 5).

This specification uses the following definitions related to process summary, macro flowchart and micro flowchart.

Macro Flowchart—a flowchart giving a big picture of a selected global workflow process-box (see FIG. 5 for an example).

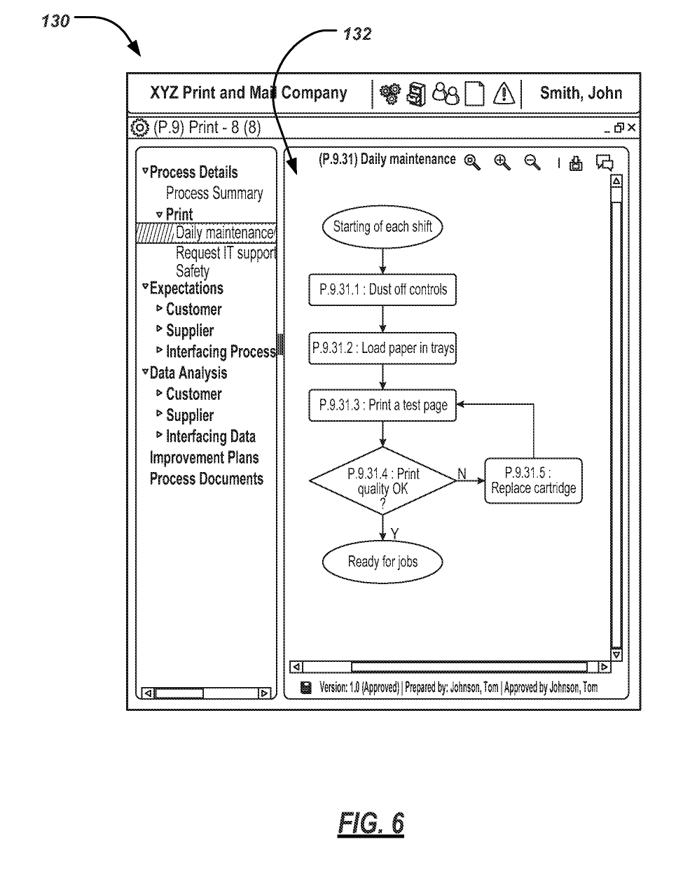

Micro flowchart—provides detailed process steps of a macro flowchart, or other micro flowchart (see FIG. 6 for an example).

Output—a deliverable of a process.

Internal Customer—either a process that receives the output of a preceding process or a process that has the product or service pass through it before reaching the external customer. The system can use the process names from the global workflow as the internal customer name.

External Customer—a customer who is outside the organization. External Customers keep the organization in business by paying for products or services.

Inputs—things or information that are used by the process and converted into an output.

Internal Suppliers—processes that provide the inputs to a process. The system can use the process names as they appear on the global process flowchart, for the name of the internal supplier.

External Suppliers—suppliers who are outside the organization.

Help—something that makes doing the work in this process either easier, better or more efficient. Help is different from input, because ‘input’ is something that is converted into output, and help is not.

Interfacing process—a process that provides help to this process or receives help from this process.

The system has the process leader select a process-box from the global process flowchart that they lead. The system presents a summary of the process, like shown in FIG. 4, to which the process leader can input process information in to the system.

FIG. 4 shows an input screen 90 for a process summary 92 that gathers and displays information about the process. The system receives information about why the organization needs this process with a description 94 that should be about two or three sentences long. In the middle of the process summary 92 is a process-box 96 that represents a process from the global process flowchart 62, see FIG. 3, which should match by label and name, in this case “(P.9) Print.” An arrow from the process-box 96 points to an output box 98. The output box 98 identifies the process outputs. The outputs could be products, services or both. To the right of the output box 98 is a customer process box 100 that identifies the processes that receive and use this process's outputs. One output may go to more than one customer. An input box 102 is to the left of the process-box 96 and an arrow comes into the process-box 96 from the input box 102. The user uses the input box 102 to identify the inputs required for producing the outputs. To the left of the input box 102 is a supplier process box 104 that allows the user to enter information about the supplier processes that supply inputs to this process. In addition to the customer processes and supplier processes, there are also interfacing processes. Interfacing processes are located below the process-box 96 at interface box 106, where the interface box 106 is connected by an arrow coming out of the process box 96. The interface box 106 is used to identify the interfacing processes. Interfacing processes are those processes needed to help the process identified in the process-box 96 to function properly, and also any processes that need help from this process.

The system has the process leader prepare a macro flowchart of the processes on the global process flowchart that he/she is responsible for. The macro flowchart shows the detailed activities performed by a process. Every process should have sequential activities, independent activities or both. Some enabling processes may only have independent activities. The macro flowchart should use the same symbols as the global process flowchart. The macro flowchart should have the sequential activities connected with arrows. There can be more than one input and more than one output for a given process. The macro flowchart should show independent activities in separate boxes set off from the sequential activities. Independent activities are those activities that are the responsibility of the process owners, but do not fit into the sequential activities, for example, housekeeping and preparation of weekly reports.

FIG. 5 shows a screen shot 120 of an embodiment of the system displaying a macro flowchart 122 for a process “P.9: Print” 82 of the global process flowchart 62 seen in FIG. 3. The macro flowchart 122 shows the sequential activities of the process flow with connect boxes 124 and independent activities as independent boxes 126 at the bottom. The flowchart 122 indicates process-boxes that have more detail with shading 130.

The system will indicate the effective date of the process. The system indicates the boxes where more details are available in micro flowcharts, for example, the boxes could be shaded. The system numbers the process boxes as PX.1, PX.2 etc, where X is the parent process-box's number. For example, expanding process P3 the numbers of the boxes in the macro flowchart would be P3.1, P3.2, etc. Expanding process-box E5 the boxes would be numbered E5.1, E5.2 etc. The system prevents duplicate numbering of flowchart elements.

If appropriate, the process leader should prepare schematic diagrams and/or layouts depicting the arrangement of equipment and product flow, show piping arrangement for fluid flow (air, vacuum, steam, chemicals . . . ), and other relevant schematic diagrams. The system can accept uploaded documents of these diagrams or layouts, and the system can track revision history of these documents over time.

The process leader should share the process summary and macro flowchart with the process owners, and involve the process owners in preparing micro flowcharts. Process owners are the individual workers who do the work.

As necessary, the process owner should use the system to expand any of the process-box on the micro flowchart into additional micro flowcharts. The process owner should create as many levels of micro flowcharts as necessary to ensure clarity in understanding by those who are not thoroughly familiar with the process. Eight to ten boxes per micro flowchart is preferred. Micro flowcharts may contain boxes that themselves have micro flowcharts. The system can indicate a process-box has more detail, for example with shading. The micro workflows often will go three and four levels deep. The system can automatically number the nested micro flowcharts. For example, expanding process P6.3 would have process-boxes in the new micro workflow's named P6.3.1, P6.3.2, etc.

FIG. 6 shows a screen shot 130 from an implementation of the system that depicts a micro flowchart 132 that is an expansion of the macro flowchart 122 process “P.9.31: Daily maintenance” 128 shown in FIG. 5.

The system can house training materials relevant to the processes it has documented. This would provide an improved way of providing “training on the job” by keeping all the process descriptions and training material up-to-date and in one place.

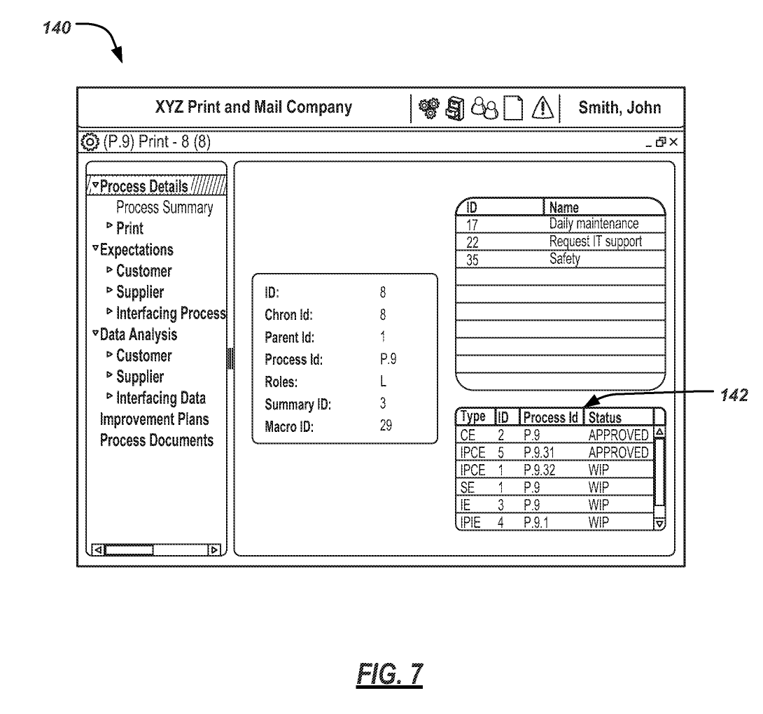

While users are using the system to document the processes, the system could allow others to view the information under development, which can facilitate improved communication within the organization. FIG. 7 shows a screen shot 140 from an embodiment of the invention that shows the details of status of the macro and micro flowcharts that provide details for process box “P.9: Print” 82 in the global process flowchart 62 seen in FIG. 3. The screen shot 140 provides details 142 of the macro flowcharts and micro flow charts and their status, providing their “process id” and status such as “APPROVED,” “WIP” for Work in Progress etc.

The system could provide a streamlined process for approving/reviewing process documentation. The approval process can involve notifications sent by email or provided when the user logs into the system. For example, the system could notify the sponsor when an original or revised process summary, macro flowchart or customer expectation has been posted and is in need of their approval. The system could then notify the poster when actions are taken on their requests, telling them about approvals or rejections. The appropriate process leaders and process owners of processes that are customers of this process's outputs could be notified when a change occurs to a process that affects them. This helps ensure transparency and confidence in the system's representation of the processes. For changes to supplier inputs, the request for the changes could require approval of the supplying process's process leader. To help implement these approval processes, the system could provide a list, or queue of changes, that are pending approval.

Once a change is approved then an alert could be sent out to the organization. The alert could be displayed when the user logs into the system, or sent via email or other means. When a process summary, macro flowchart, or expectations are revised, an alert could be sent out. The alert could be sent out when new global documents are released, attached or published in the system.

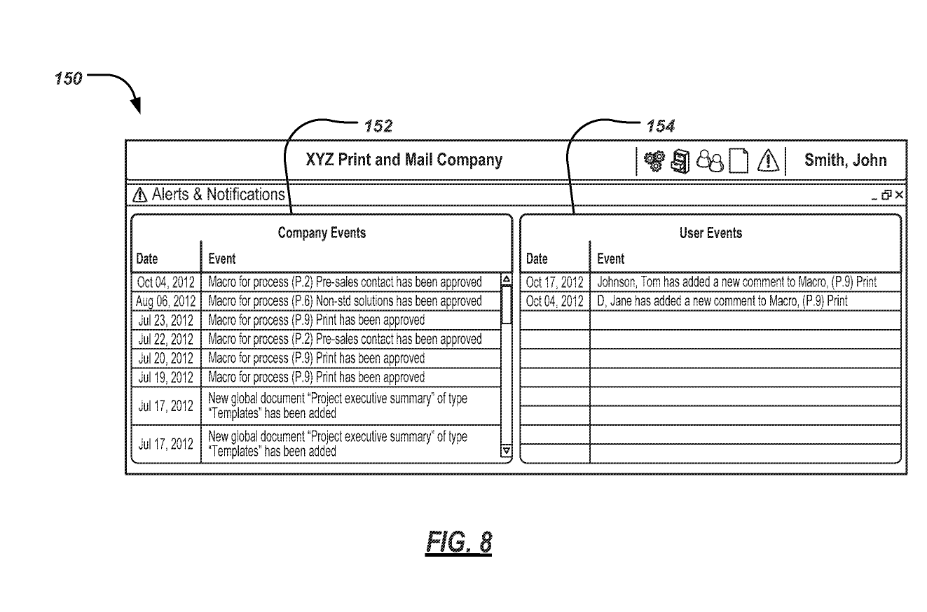

FIG. 8 shows a screen shot 150 from an embodiment of the invention that shows alerts and notifications. The screen shot 150 has a “Company Events” section 152 that lists events and alerts for the whole organization, for example, a macro flowchart being added and then a separate entry for a flowchart being approved. The screen shot 150 also has a “User Events” section 154 that shows events and alerts for flowcharts that are the user's responsibility.

The system could allow for searching of the process information. For example, in a process flow for a printing company, the system could allow searching for all occurrences of “ink” or any other word that a user enters.

### Understanding and Clarifying Expectations

Proper understanding of expectations can lead to changes in processes necessary to better meet internal customer needs, which results in improved organizational performance. The organization should keep the expectations simple, developing the expectations while looking at things from the customers' point of view.

So, how are customers satisfied, and how do the process leaders and process owners know whether the customer is satisfied? The process leaders and process owners need to know what the customer needs and expects from their products or services. Then, the process leaders and process owners translate those expectations into measurable parameters and clarify what the processes need to deliver (the preferred framework is to refer to what the ‘processes need to deliver’ instead of ‘what people need to deliver’).

There are three kinds of expectations. First, what the customers expect from the outputs. Second, what inputs are expected from suppliers. And third, what help is expected from interfacing processes.

The process leaders and process owners need to keep in mind that if they do not meet the internal customers' needs and expectations, it is very difficult (and many times impossible) for the next process to satisfy their customers' needs and expectations. Consequently, the ultimate customer is not likely to get what he or she expects from the organization, resulting in dissatisfaction and loss of business, ultimately resulting in loss of jobs and salaries.

Therefore, it is of paramount importance that at each stage the organization clearly identifies what the internal customers expect from the previous processes in order for the organization to meet the customer expectations. With the system documenting the processes, it can be discovered that current processes do not meet the customer expectations; which can actually be good news since the organization then knows what it needs to improve.

The process leaders and process owners should reference the process summary as they gather and input the expectations in the system. The process leaders and process owners should start with the outputs of the process and the customers who receive the output be they internal customers, external customers or management. Then process leaders and process owners should proceed to the inputs that are required to produce the outputs. Those suppliers that provide the inputs should be listed, both internal suppliers and external suppliers. The process leaders and process owners need to identify the help needed to do the work in the process, and those processes that provide the help, where these processes are the interfacing processes. In summary, “Outputs” go to customers both internal and external, “Inputs” come from suppliers both internal and external, and “Help” is received from or given to interfacing processes.

The process leaders and process owners should identify the customer expectations. Every process has one or more outputs (deliverables) and has customers, either internal, external or both. One customer that every process has is management. The focus for gathering customer expectations should be on satisfying the expectations of internal customers. In many cases, the internal customer is only the next process. However, in some cases processes down-stream may have certain expectations from an upstream process that the intermediate processes ignore. The process leaders and process owners should capture these down-stream expectations in the system as outputs of the process.

Next, the process leaders and process owners need to determine what the customers expect from the process. This starts by describing the customer's expectations, for example, good quality, right quantity, good detail in reports, etc. Remember that internal customers expect output to be in a certain way, just as the process expects to receive inputs in a certain way.

The process leaders and process owners need to identify the process measurable parameters and units of measure. The process leaders and process owners are likely to wrestle with the question as to how to measure what the customers expect. It is important to identify the customer expectations because what cannot be measured cannot be improved. Measureable parameters could be product parameters, such as dimensions; process parameters, such as temperature, pressure, speed etc.; or service parameters, such as speed of delivery or accuracy of information in reports.

The process leaders and process owners need to determine what the customer considers acceptable values for the measured parameters and enter that into the system. The measure parameters will have a desirable value known as a ‘target’ and acceptable limits known as a ‘range’. The ‘target’ value is what the customer would like it to be if it were possible to make every item exactly the same. Since it is not possible to make all items exactly the same, what variation is the customer willing to accept? This ‘range’ of acceptable values has a minimum value below which the customer would be dissatisfied. The ‘range’ has a maximum value above which the customer would be dissatisfied. Sometimes, there is only one of these values—minimum or maximum and sometimes there is both the minimum and maximum.

The process leaders and process owners need to obtain agreement from the internal customers about the internal customer's expectations. For external customer expectations, the process leaders and process owners need to confirm with appropriate people in sales, customer service, program management, etc. that the system has the correct external customer expectations specified. The system should have the expectations of management identified, since management is always a customer of every process.

The system can have the customer expectations go through an approval process. For example, after the process owner enters the expectations, the system could require approval by the process leader or the sponsor before the expectations are marked approved and are ready to have data gathered against them.

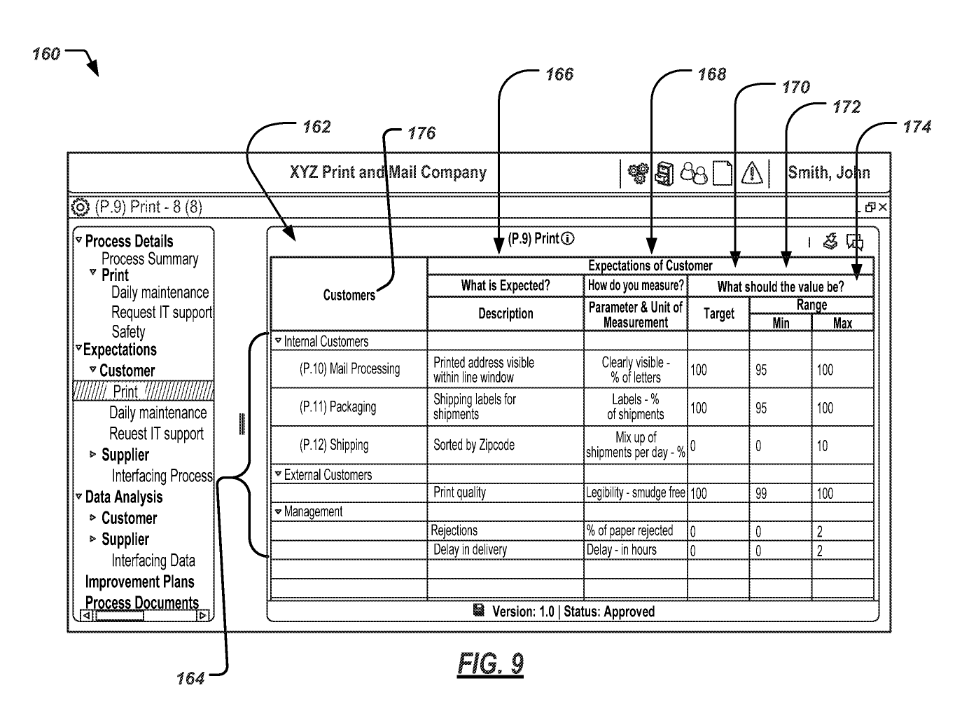

FIG. 9 shows a screen shot 160 of an embodiment of the system with the expectation parameters are being specified for the “P.3: Print” 82 of the global process flowchart 62 seen in FIG. 3. The screen shot 160 shows a row for each customer expectation 164 organized by internal customers, external customers and management. For each expectation, the system has the user provide, in input cells organized by columns, a description 166, a parameter name and unit of measure 168, a target value 170, and the range for minimum value 172 and a maximum value 174.

The system can prompt the users to review the expectations periodically, for example once a year, or the system could be used earlier than the periodic review, for example, if the process leader decides it is appropriate because of business model changes.

The process leader and process owners also need to identify for the process the inputs that are required to produce the process outputs. The inputs come from internal and external suppliers. Internal suppliers are part of the organization and have process-boxes on the global process flowchart. External suppliers are companies and agencies external to the organization. The expectations for the inputs can follow the same guidelines discussed above for customer expectations. The system can capture the expectations as described above using a screen like FIG. 9, but replacing “Customer” with “Supplier”, for example, the “Customers” title 176 would be replaced by “Suppliers.”

In addition to the inputs, the process may require some help from other processes that are not providing inputs, where an input is something that gets converted into an output. Any required support, other than the inputs, should be captured as an interfacing process, for example, training, information technology support, etc.

The interfacing processes should capture only relevant items. The process leader and process owners should take care to avoid filling the list with trivial items. If this process requires some help from some other processes, chances are high that those other processes are not aware of this process's needs. Therefore, the process leader and process owner may have to communicate this processes' needs to those other processes. It is a two-way street, because there are ‘mutual expectations’ between interfacing processes.

It is possible for a process to be a supplier as well as an interfacing process. It depends on the nature of inputs provided and help given. For example, in a power intensive manufacturing operation, a utilities process can be a supplier supplying ‘power’ that can be viewed as input. The same utilities process can also be an interfacing process when providing uninterrupted electricity for lighting and computer equipment. In another example for a labor-intensive software operation, a Human Resources department can be viewed as a supplier when providing labor and can be viewed as an interfacing process when providing training.

The process leader and process owners should determine what help this process needs from the other processes it interfaces with. The process leader and process owners should also determine what help other processes in the organization expect from this process, and what information does this process need from the other processes.

The system can capture the expectations as described above using a screen like FIG. 9, but replacing occurrences of “Customer” to “Interfacing Processes,” for example, changing the “Customers” title 176 with “Interfacing Process.” In addition, the columns would be repeated with one set title “Your Expectations” for capturing the expectations this process has for the interfacing processes, and a second set titled “Their Expectations” for capturing expectations the other processes have for this process.

To ensure that all agree with the expectations, this process's process leader and process owners should review and approve the expectations, and the interfacing processes process leaders and process owners should review and approve the expectations as well. With the expectations entered into the system, the system can also help coordinate the expectations by matching-up and compare the interfacing processes expectations to help identify and resolve differences.

The system can identify any customer of a process that does not have expectations established. The system can prompt for the expectations or could produce a report that lists any process-customers that do not yet have expectations set.

The system could provide feedback to the supplier processes regarding whether their output (which are this processes inputs) meet the expectations of this process. The system could look at the expectations that are recorded for the suppliers' input and correlate those with the corresponding upstream process's “customer's expectation,” that are actually measuring the same actual parameter. The expectations that measure the same actual parameter should match because of communication that went on between the process leader of this process and process owners of the upstream process. But, if the expectations do not correlate then the system could highlight the mis-match.

### Data on Process Performance

In a competitive business market, whether an organization has the data and how the organization reacts to the data makes the difference between winning or losing.

The system helps to manage with facts, not opinions. Traditionally it is difficult to get facts. In the traditional management style, it was common for data to be used to find faults with others and then to blame and punish people. It was common to ‘shoot the messenger’. This behavior of bosses was a direct consequence of the belief that they ‘manage people to get results’ and “if only people did what I told them to do, there would be no problems.” Over a period of time, people learned not to tell the boss what the boss did not want to hear and buried the problems. Therefore, if anybody wanted to know what really happened, he or she needed to investigate and ‘dig for facts’. Under such an environment, it would be almost impossible to collect appropriate and accurate data. This system helps change this attitude by removing the fear of the data. The guiding principle is, “results come from processes (systems).” People making mistakes only accounts for less than 10% of the problems and that the causes for the other 90% of the problems are in the way things are done, the organizational processes.

The system helps transform the mindset from blaming people to finding out where the processes are breaking down. When things go wrong, supervisors and managers need to ask first, “what in the process broke down?” not “who did it?”, and this system can help provide the answer to where the process broke down.

Supervisors and managers need to understand and demonstrate their understanding that the majority of the causes for the problems they are experiencing are in the way things get done (organizational processes and organizational systems) and that the purpose of data collection is to improve the existing processes.

Facts are not always pleasant—there will be good news as well as bad news. It requires organizational maturity to face facts. The organization can learn from both good news and bad news, especially from bad news, if the organization approaches the data with a proper attitude and perspective.

From the expectations entered, the system knows what the customers expect from the processes, and the system can now collect data on the critical aspects of the processes to find out what the processes are actually delivering. The system could present a list of all the expectations, and from that list the user could select the ones to be monitored. The list of customer expectations is reviewed and from that list what is most important to the customer is identified. Or, the system could just monitor all the entered expectations.

For the expectation parameters, the customers want the target value, or at a minimum, they want the parameter to be within the target range. The system will collect data about what the process actually delivered.

The system collects data on what the process is producing relative to the expectations. The collected data can be in summary format. In other embodiments, the system could use the raw data and calculate the actual statistics summaries (average, minimum, maximum and % out of range). The system could collect the raw data, periodically (for example, weekly, monthly by specific project or by batch, depending on the nature of the process) then the system could calculate the system averages. The system can use other time-periods besides monthly. The system could have the ability to get performance data from other systems or from files on a user's computer such as an Excel file or a comma separated value file. The data could be statistical summary information or raw. For raw data, the system would calculate the statistical summaries from the raw data.

If the organization cannot measure the parameters themselves then the organization would request appropriate data from the customers.

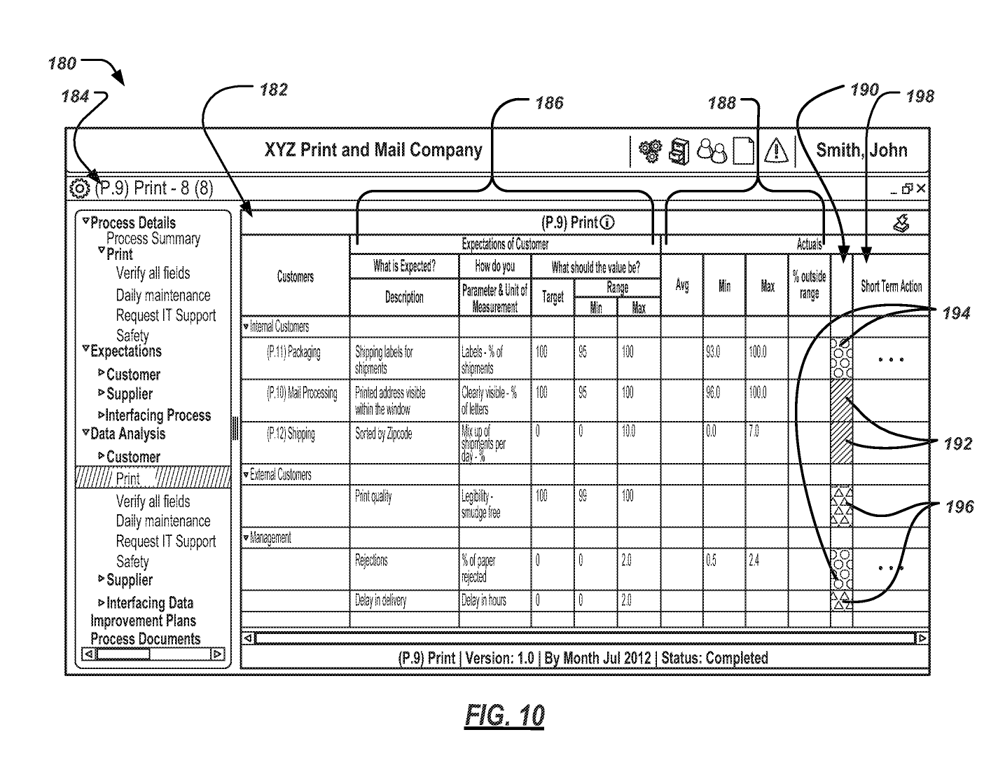

FIG. 10 shows a screenshot 180 from an embodiment of the system including a data analysis 182 of the process “(P.9) Print” 184, which is the process for the process box 82 of the global process flowchart 62 shown in FIG. 3. The data analysis 182 includes all expectations for process “(P.9) Print” 184. The data analysis 182 presents each expectation as a row with columns labeled 186 providing information about what are the expectations of the parameters. The columns labeled 188 indicate what the actual process is producing. The system provides a column 190 indicating the status of the expectations, where parameters that meet expectations are indicated with green 192, parameters that fail to meet expectations are indicated with red 194, and if the data has not yet been provided that is indicated with yellow 196. A column 198 allows the user to describe short term actions taken to address the measurements that fail to meet expectations.

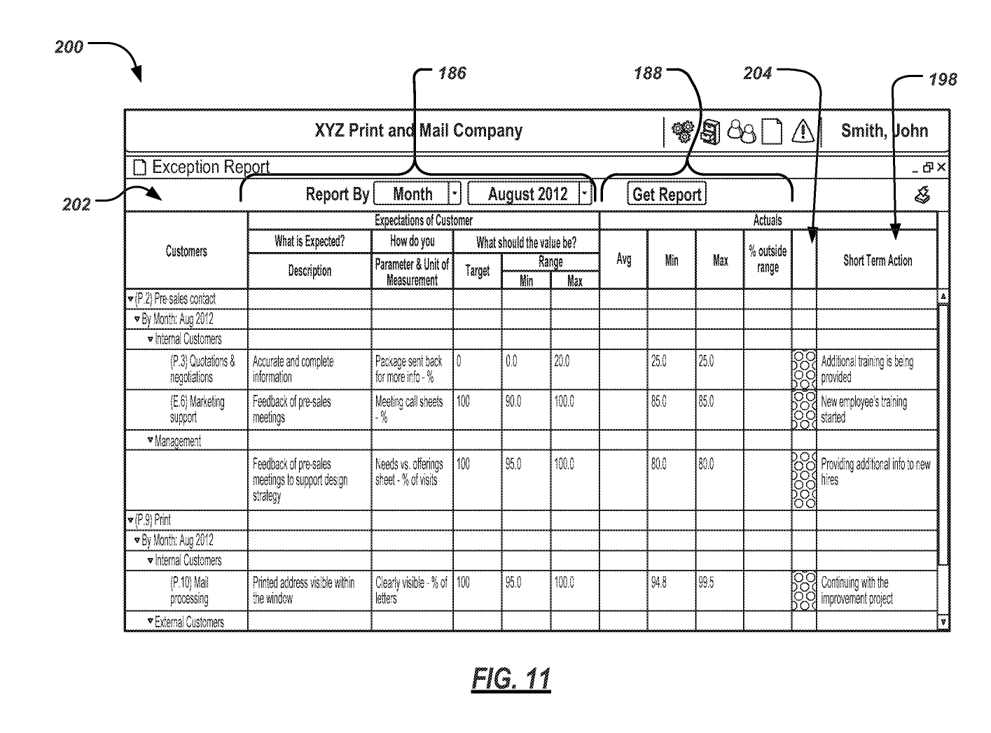

FIG. 11 shows a screen shot 200 from an embodiment of the system including an exception report 202. The exception report 202 can include only those expectations that do not meet the expectations, or those expectations that are missing actual data and those that do not meet the expectations. Each expectation is presented as a row, and the columns 186 provide information about what are the expectations of the parameters. The columns indicate what the actual process is producing 188. The system can provide a column 204 indicating why an expectation was not met, for example, red can indicate the actual process data fails to meet the target and range, and yellow can indicate the actual data has not yet been received by the system. A column 196 can be provided to allow the users to describe short term action plans to address the exception.

Complicated calculations should be avoided when collecting data on process performance. What data is needed is simple, the organization just needs to collect what was expected by the customer and what was provided to the customer. The organization should not complicate the data collection process by combining what was delivered with why the processes failed to deliver what was expected. This kind of root-cause analysis comes after proper data collection.

The system can present data to allow the user to review what is expected from the supplier processes and identify which of these parameters are critical in order to deliver what is important to the customer processes. After the system collects data on the list of parameters, the system could analyze the data and display the data pictorially, for example, preparing run charts for each parameter. Run charts show trends over time. The system could prepare Pareto charts and histograms as well.

The system could provide the ability for a user to comment or ask a question about a process in real time and receive answers. For example, the comments or question could be sent to the process leader responsible for the process, and that process leader could respond appropriately. This would provide a way to improve communications and feedback in an enterprise about processes and the system's defined process flowcharts.

### Process Improvement Projects

The organization should use the collected information to create improvement projects, and the system can help identify those areas that need process improvement. The organization should remember the guiding principle “continually improve processes.” Continual improvement of processes is necessary to continue to meet the changing requirements of customers, which is a prerequisite to staying in business. Areas for improvement come from two sources. First, the gap between what the customers expect and what they are getting today and second from business planning—things that need to be done differently.

Based on the data gathered, the system can help identify the exceptions where what the customer expects is not what the current process delivers. The system can help identify what areas within the process need to be improved to address the exception. Those parameters that need to be improved are indicated by the system as described above in the exception report. The parameters that need to be improved are updated regularly, for example, monthly. In one embodiment, the exception report will be automatically generated. The exception report summarizes in one place all process parameters that are either out of range (red color) or not being measured (yellow color).

The majority of the causes that keep customers from getting what they expect are imbedded in the processes. Therefore, to resolve the issue, the process needs to be modified to improve. The organization should create process-improvement project teams. The system can help ensure only one team is working on improving a particular process at a time. The system can notify sponsors or others when the improvement project teams have updated their progress and can then encourage the improvement project teams for keeping their status up-to-date and for their accomplishments.

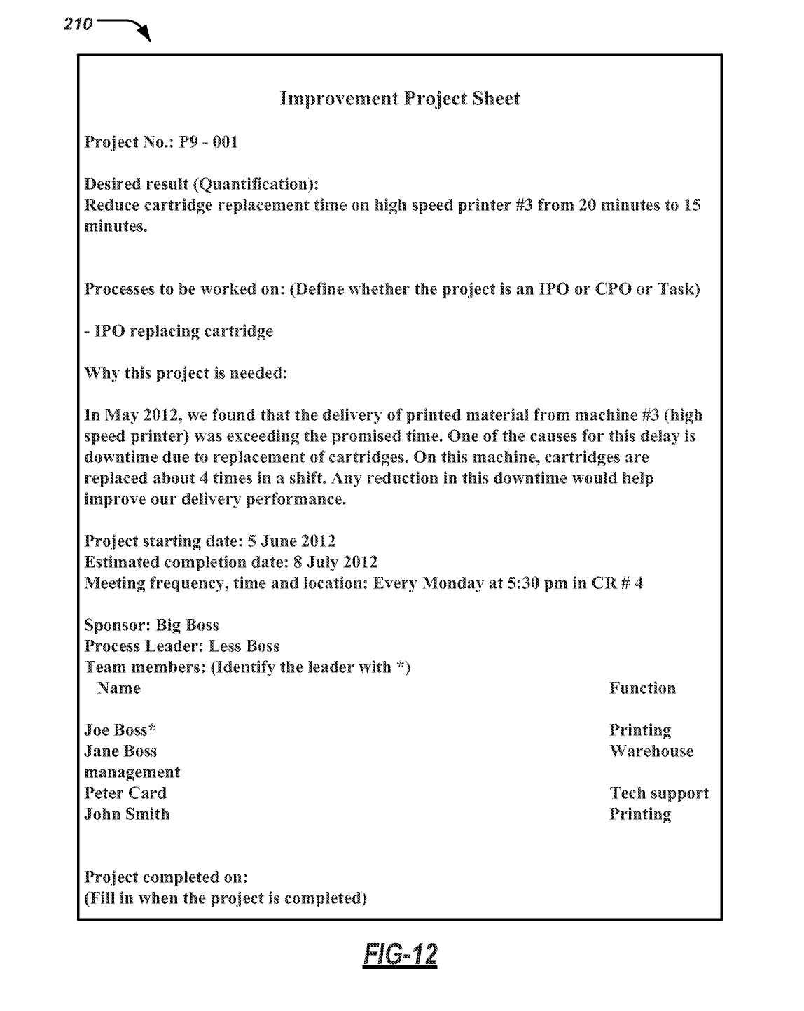

The system organizes all the data for each process-improvement project and captures different versions of the process-improvement project documents. FIG. 12 shows an example of a process improvement document 210. When a process-improvement project is completed, the system can capture the affected flowcharts, and show the revision levels and date. When training people in the revised process, information from the system about the process-improvement project can be used.

Integration of Organizational Strategy into Processes

The organization should discuss the process-improvement projects during a periodic business planning process or a strategy integration process. For example, the periodic business planning could be an annual business planning session. A strategy integration process can be used to develop Goals Sub-approaches Matrices (GSM) that the system can keep track of. The GSM should be created to address the changes in the business climate. The system could associate the process-improvement projects with the GSM, this could provide the ability to quickly view and drill down from the organization's strategic goals into all relevant processes, data, action plans etc. The system can allow related templates (for data collection, cause and effect diagrams, storyboards etc.) and findings (e.g. filled in templates) to be stored, retrieved and associated with process-improvement projects. With these associations, the system has a way of capturing improvement projects needed to support business goals. The system can allow process-improvement projects to set and track deadlines and report on how all project teams are meeting their deadlines.

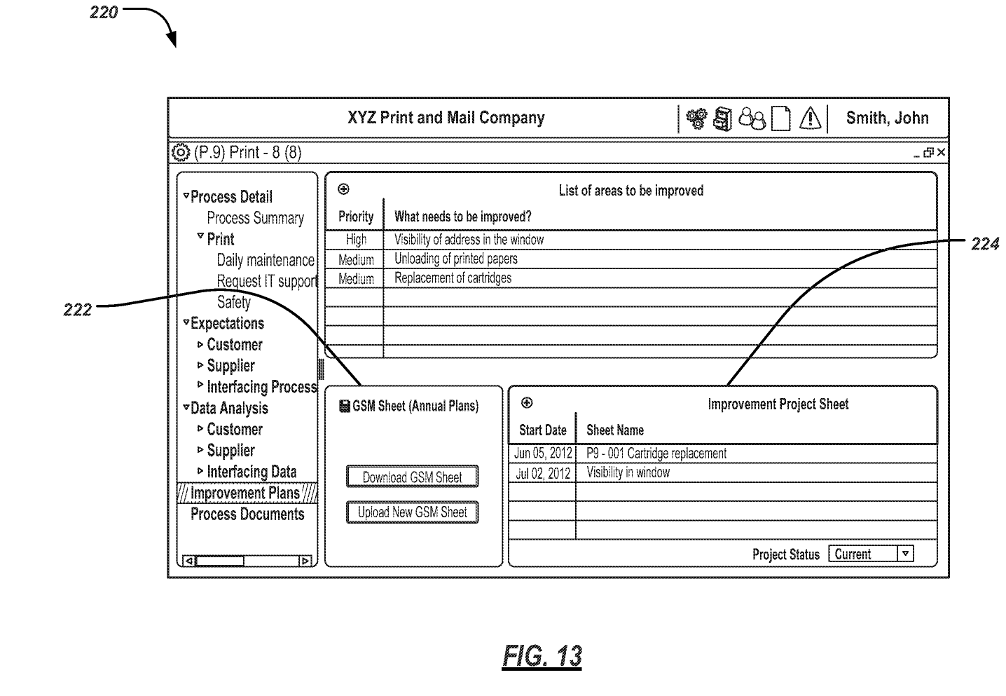

FIG. 13 shows a screen shot 220 from an embodiment of the invention that includes process improvement plans for process “P.9: Print” 82 of the global process flowchart 62 of FIG. 3. There is a section 222 to allow storage and retrieval of the GSM Sheet in the box labeled “GSM Sheet (Annual Plans)” that has an “Upload New GSM Sheet” button for the system to receive new GSM Sheets and provides access to the current version or a previous version of the documents through the “Download GSM Sheet” button. There is a section 224 titled “Improvement project Sheet” to track improvement projects.

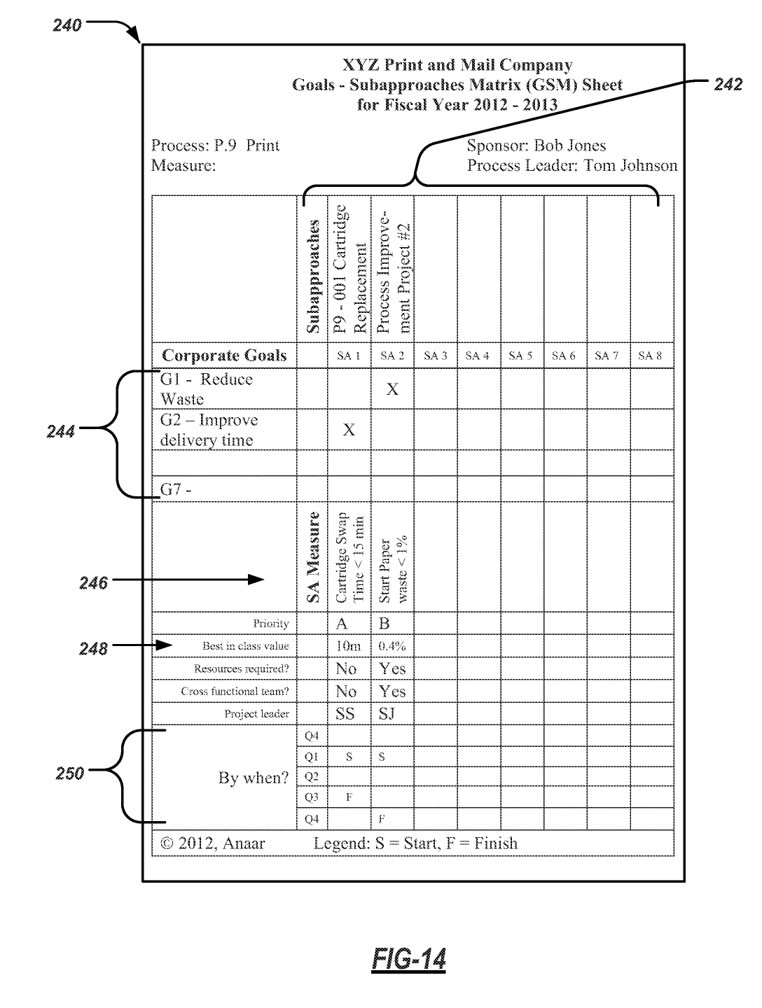

FIG. 14 shows an example of a GSM sheet 240. The GSM sheet 240 has columns 242 for each process-improvement project's measurement. The GSM sheet 240 associates the process-improvement projects with corporate goals 244 by placing an “X” in the intersecting cell. Each column has a measurement that is described in the “SA Measure” (Sub Approach Measure) row 266. In the row labeled “best in class value” 248, the GSM sheet 240 can provide a measurement target that would be best in the industry. It may be necessary that to achieve the “best in class” value more than just this process-improvement project will be needed. It helps to display the “best in class” value on the GSM sheet 240 to remind those involved with the project what the organization needs to achieve in the long-term, to be competitive in the marketplace. The GSM sheet 240 also has a timing table 250 that provides information about when the process-improvement project is scheduled to start and finish. The system can use the finish date to help report if the process-improvement project is on-time.

The system can organize all process-improvement project documents to make them available in a convenient ready to access format. This convenient access could be made available through a computer that is physically located in the vicinity of the process. With all the information in one place for the process-improvement projects, it is extremely convenient for the process owners to access the information and utilize it for troubleshooting and other purposes. The process-improvement project documents could include templates (such as data collection, cause and effect diagrams and storyboards), filled in forms, and the ability to drill down into the details on any process-improvement projects relevant to the processes in the vicinity.

### Accessibility and Benefits of the System

The system could allow for integrating enterprise-wide processes accessible from anywhere by making the data available to a network of computers such as a company internal network or the internet. With computer network access, the information in the system could be access from anywhere, even from home, and it could be accessed concurrently. The system can show the customer expectations with measurable parameters. A network capable embodiment would enable the ability to enter actual data by process owners from any location. The system can take individual process performance parameters and display them with color-coding for easy of interpretation and to help users quickly focus on those process performance parameters that need attention. The system can display short-term actions when performance is not within the expected range, linking process-improvement projects to specific processes and showing the status of process-improvement projects.

The benefits of the system include: making people document the actual processes, facilitating recording and sharing pertinent data, providing an objective framework for discussing issues, integrates knowledge into organizational processes—knowledge is not lost when people move or leave, and creating greater transparency.

In addition, there are long term benefits of the system including ease in meeting compliance requirements, such as ISO certification consistent results; fewer barriers between departments; faster response; more agility; better employee morale; improved customer satisfaction; and a healthier bottom-line.

The system helps transform the work culture: and helps organizations transform its work culture to a high performance state. The system helps establish strong customer focus throughout the organization. The system helps bring in a factual approach, reduces defensiveness, bring in a culture of listening, develop pride in workmanship, and prepares the organizational mindset for improvement. Above all, the system helps increase “respect for people.”

The foregoing discussion discloses and describes merely exemplary embodiments of the present invention. One skilled in the art will readily recognize from such discussion and from the accompanying drawings and claims that various changes, modifications and variations can be made therein without departing from the spirit and scope of the invention as defined in the following claims.

Give all terms used in the claims their broadest reasonable construction and their ordinary meaning as understood by those skilled in the art. Use of the singular articles such as “a”, “the”, “said”, etc. should be read to recite one or more of the indicated elements.

What is claimed is:

1. A computer system for managing processes in an organization where the system comprises:
a computer with a memory having instructions that:
determine a process flow for an organization with a global process flowchart having a set of processes, where a first process from the set of processes has a macro flowchart that has a sub-process, and the sub-process has a micro flowchart, and where the set of processes includes a set of primary processes and at least one enabling process, where the set of primary processes process the organization's orders, and the enabling process enables at least one primary process, and where a second process in the set of processes has an associated process leader who is responsible for the second process, where the first process and the second process can be the same process;
associates individual process summaries to individual processes from the set of processes, where each process summary has at least one related process selected from a list of a customer process, a supplier process and an interfacing process;
associates the related process with a parameter to measure, where the parameter to measure is an aspect of the individual process, and where the parameter has expectations for the measured values;
receives actual measurement information about the parameter from the processes in the organization; and
generates a report about those parameters whose actual measurements do not meet the measurement expectations.

2. The computer system of claim 1 further including making the process flow available to a networked computer.

3. The computer system of claim 1 where there is an approval process when the computer system determines the process flow or a revision to the process flow.

4. The computer system of claim 3 where the approval process automatically records a version number, a preparer name, an approver name and an approval date.

5. The computer system of claim 4 where previous versions of the process flow are available from the computer system.

6. The computer system of claim 4 where the system generates alerts or messages regarding activities that occurred in the system.

7. The computer system of claim 6 where the generated alerts or messages are filtered to only present the messages relevant to areas of responsibilities of a user.

8. The computer system of claim 6 where the activities are relevant to the approval process.

9. The computer system of claim 1 further comprising searching the process flows.

10. The computer system of claim 1 further comprising making comments on the second process and have the second process' process leader receive that comment.

11. The computer system of claim 10 further comprising recording a process leader's response to the comment.

12. The computer system of claim 1 wherein making the process flowcharts includes making the process flowcharts available concurrently as the process flowcharts are being developed to another computer in communication with the computer system.

13. The computer system of claim 1 where a process-improvement project is associated to a process from the set of processes.

14. The computer system of claim 13 wherein the process-improvement project is associated to a business plan, where the business plan includes a strategic goal.

15. The computer system of claim 14 further comprising storing and associating a finding to the process-improvement project.

16. The computer system of claim 14 further comprising facilitating the review of the process-improvement projects, including status.

17. The computer system of claim 16 wherein the facilitating the review of the process-improvement projects includes reporting on those process-improvement projects that are behind schedule.

18. The computer system of claim 18 wherein the reporting of the process-improvement projects includes report on all the process-improvement projects that are behind schedule at one convenient location.

19. The computer system of claim 1 further comprising providing access to the process flow in a physical vicinity closest to the actual processes.

20. The computer system of claim 1 where receiving actual measurements happens automatically.

21. The computer system of claim 1 further comprising finding discrepancies between expectations for parameters that measures the same feature where one parameter is measuring the feature as output from a upstream process and the other parameter is measuring the feature as input to a downstream process, where the upstream process and the downstream process are members of the set of processes.

22. The computer system of claim 1 further including recording a short term action being taken to address the parameters whose actual measurements do not meet the expectations.

23. The computer system of claim 1 further including from the list of processes and avoiding duplicate numbers.

24. The computer system of claim 1 further including reporting which related processes fail to have the parameter to measure specified.

25. The computer system of claim 1 further including storing a document pertinent to a process from the set of processes.

26. The computer system of claim 1 where the report about those parameters whose actual measurements do not meet the measurement expectations is at one convenient location.

27. A computer system for managing processes in an organization, the computer system comprising:
means for defining an organizations' processes in the computer system;
means for defining expectations of the processes in the computer system;
means for receiving actual measurement information about the expectations of the processes; and
means for notifying when the actual measurement information does not meet the expectations and when the actual measurement information is missing.

28. A computer program product, tangibly embodied on a machine readable medium, the computer program product comprising instructions that, when read by a machine, operate to cause a computer system to:
determine a process flow for an organization with a global process flowchart having a set of processes, where the set of processes includes a set of primary processes and at least one enabling process, and where the set of primary processes process the organization's orders, and the enabling process enables the primary processes to perform their functions;
associate individual process summaries to processes from the set of processes, where each process summary has a set of related processes including a customer process, a related supplier process and a related interfacing process;
make parameter associations that associates the related processes with parameters to measure about the processes, where each parameter has a set of measurement expectations;
receive actual measurement information from the process about the parameters;
generate a report about those actual measurements that do not meet their measurement expectations; and
generate a report includes notifying when actual measurement information is missing.

29. The computer program product of claim 28 further comprising create alerts and notification about changes to flowcharts in the system.

30. The computer program product of claim 28 further comprising associating a process-improvement project with a process from the set of processes, where the process-improvement project has tasks with due dates and reports when due dates are not met.
